(19) United States
(12) Patent Application Publication
(10) Pub. No.: US 2015/0015771 A1
(43) Pub. Date: Jan. 15, 2015

(54) IMAGE-CAPTURING DEVICES AND METHODS

(71) Applicant: Acer Incorporated, New Taipei City (TW)

(72) Inventors: Wei-Kuo Shih, New Taipei City (TW); Chao-Kuang Yang, New Taipei City (TW)

(73) Assignee: Acer Incorporated, New Taipei City (TW)

(21) Appl. No.: 14/254,230

(22) Filed: Apr. 16, 2014

(30) Foreign Application Priority Data
Jul. 10, 2013 (TW) 102124661

(51) Int. Cl. H04N 5/232

(52) U.S. Cl. CPC H04N 5/23212; H04N 5/23293
USPC 348/349

(57) ABSTRACT

The present invention provides an image-capturing device including a lens with an adjustable focal length, a photosensitive unit, a memory unit, a processing unit, and a display unit. The photosensitive unit obtains a plurality of images from a scene via the lens, and the images correspond to different focal lengths. The memory unit is configured to store the images corresponding to the different focal lengths. The processing unit obtains a target image according to a selected frame position, wherein the corresponding focal length of the target image focuses on an object of the scene, and the object in the target image is located at the selected frame position. The display unit is configured to output the obtained target image.

### CROSS REFERENCE TO RELATED APPLICATIONS

This Application claims priority of Taiwan Patent Application No. 102124661, filed on Jul. 10, 2013, the entirety of which is incorporated by reference herein.

### BACKGROUND OF THE INVENTION

1. Field of the Invention

The disclosure relates generally to an image-capturing device, and more particularly relates to an image-capturing device having the function of changing the focus of the captured image.

2. Description of the Related Art

For the capture of images using conventional image-capturing devices, such as digital cameras and digital video cameras, the image-capturing devices have to set the focus first, and then take the pictures individually. However, when the contrast between the scene/object and the environment is small, it is hard to focus the camera, and the captured image may appear unclear.

Also, conventional image-capturing devices cannot adjust the focus of a captured image after the image has been captured. Therefore, if a user needs to change the focus on the image or discovers that the image is out of focus, the user has to return to the original location and retake the pictures. It is quite inconvenient for users.

### BRIEF SUMMARY OF THE INVENTION

In order to solve the problems mentioned above, the invention provides an image-capturing device. The image-capturing device comprises a lens, having an adjustable focal length; a photosensitive unit, obtaining a plurality of images from a scene via the lens, wherein images correspond to different focal lengths of the lens individually; a memory unit, storing the images; a processing unit, obtaining a target image from the images according to a selected frame position; and a display unit, outputting the target image, wherein the lens with the corresponding focal length of the target image focuses on an object of the scene, and the object is located at the selected frame position of the target image.

The invention further provides an image-capturing method for an image-capturing device having a lens with an adjustable focal length. The method comprises obtaining a plurality of images from a scene via the lens, and the images are corresponding to different focal lengths of the lens individually; storing the images; obtaining a target image from the images according to a selected frame position; and outputting the target image, wherein the lens with the corresponding focal length of the target image focuses on an object of the scene, and the object is located at the selected frame position of the target image.

### BRIEF DESCRIPTION OF DRAWINGS

The invention will become more fully understood by referring to the following detailed description with reference to the accompanying drawings, wherein:

FIG. 1 is a block diagram illustrating an embodiment of an image-capturing device according to the invention;

FIG. 2 is a schematic diagram illustrating an embodiment of a scene from which the user attempts to take a picture;

FIG. 3A is a curve diagram illustrating an embodiment of the focus value of area Aa in each image shown in FIG. 2;

FIG. 3B is a curve diagram illustrating an embodiment of the focus value of area Ab in each image shown in FIG. 2;

FIG. 3C is a curve diagram illustrating an embodiment of the focus value of area Ac in each image shown in FIG. 2; and

FIG. 4 is a flowchart of an embodiment of an operation method for the image-capturing device shown in FIG. 1.

### DETAILED DESCRIPTION OF THE INVENTION

Embodiments, or examples, illustrated in the drawing are now disclosed using specific language. It will nevertheless be understood that the embodiments and examples are not intended to be limiting. Any alterations and modifications in the disclosed embodiments, and any further applications of the principles disclosed in this document are contemplated as would normally occur to one of ordinary skill in the pertinent art. Reference numbers may be repeated throughout the embodiments, but they do not require that feature(s) of one embodiment apply to another embodiment, even if they share the same reference number.

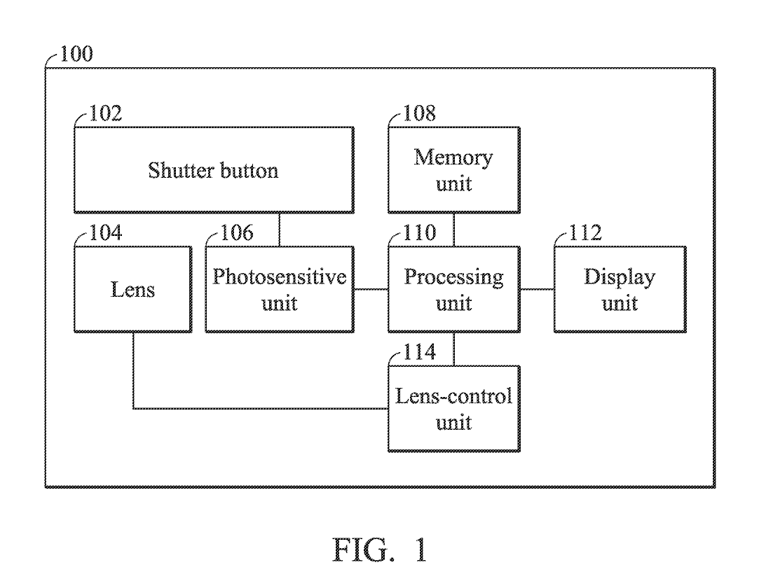

FIG. 1 is a block diagram illustrating an embodiment of an image-capturing device according to the invention. The image-capturing device 100 comprises a shutter button 102, a lens 104 with an adjustable focal length, a photosensitive unit 106, a memory unit 108, a processing unit 110, a display unit 112 and a lens-control unit 114. When a user presses the button 102, the photosensitive unit 106 may capture multiple images via the lens 104 from an external scene, and the images may correspond to different focal lengths. For example, it assumes that the lens 104 is adjustable for ten focal lengths. The photosensitive unit 106 captures image when the lens 104 switches to a different focal length, so the photosensitive unit 106 captures ten images with ten different focal lengths. It should be noted that the lens 104 having ten different focal lengths is only an example, and it is not intended to limit the invention. Actually, the lens 104 with the adjustable focal length may have infinite different focal lengths, so the lens 104 with the adjustable focal length can be set to have any number of focal lengths according to the user's needs. Further, in some embodiments, the lens-control unit 114 can drive the movement of the lens 104, or drive the movement of the inner lens in the lens 104, to adjust the equivalent focal length in order to perform the changing of the focal length of the lens 104. Furthermore, although a physical shutter button 102 is installed in the image-capturing device of the embodiment, the shutter button 102 should not be limited to a physical shutter button or a software shutter button. The image-capturing device can have no physical shutter button or a software shutter button, and the user can use gestures, voice-control, motions, or a control unit to capture an image with the image-capturing device.

After the photosensitive unit 106 obtains multiple images, the memory unit 108 stores the images captured by the photosensitive unit 106. In addition, in some embodiments, after the photosensitive unit 106 obtains multiple images, the display unit 112 further outputs one of the multiple images as a preset image according to a preset focal length. For example, the preset focal length may be a middle value of the adjustable range of the focal length of the lens 104, and the display unit 112 further outputs the image corresponding to the middle focal length. It should be noted that the invention is not limited thereto, and the display unit 112 can output any one of the images as the preset image according to the design. Therefore, the user can preview the captured images.

In order for the user to select a frame position for focusing on a position in the image after the images have been captured, the processing unit 110 determines a target image according to the selected frame position. When the user selects a frame position for focusing on an object, the determined target image corresponds to a focal length focusing on the object, and the display unit 112 outputs the target image accordingly. In more detail, the processing unit 110 determines the frame position selected by the user, and analyzes the image in the frame position for determining the target image. In some embodiments, the display unit 112 may be a touch display for users to select a frame position for focusing. In another embodiment, the image-capturing device 100 may comprise an input unit, such as a selection button, for users to select a frame position for focusing.

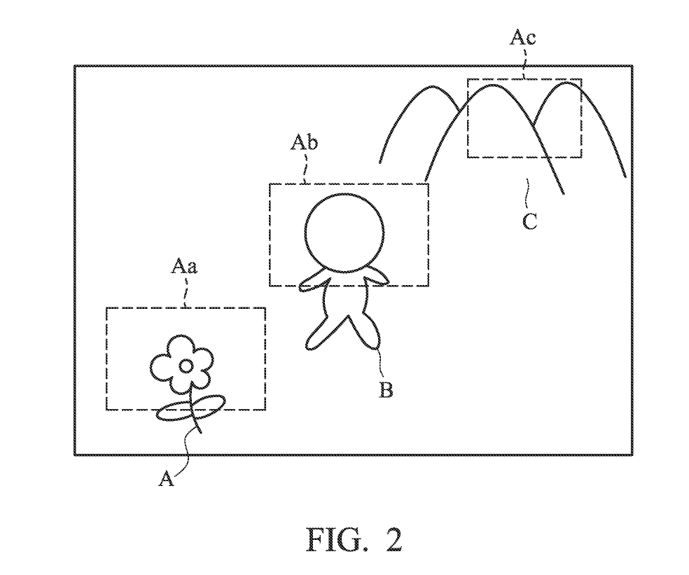

The operations of the processing unit 110 capturing the target image are described in detail below. FIG. 2 is a schematic diagram illustrating a scene from which the user attempts to take a picture. For object A, object B and object C in FIG. 2, object A is the closest to the user, and object C is the farthest away from the user. In an embodiment, when the selected frame position is located at object A, the processing unit 110 may analyze the focus value of area Aa in each of the images stored in the memory unit 108. Next, the processing unit 110 can determine which one of the images is the target image by comparing the values of the images to each other, and the focus value may be an image-contrast value of the area in the selected frame position.

In more detail, when the lens focuses on an object, the object image in the image captured via the lens should be the clearest. Therefore, the processing unit 110 may calculate the image-contrast value of the area in each of the images, and determine which image has the highest image-contrast value, wherein the image having the highest image-contrast value is the target image.

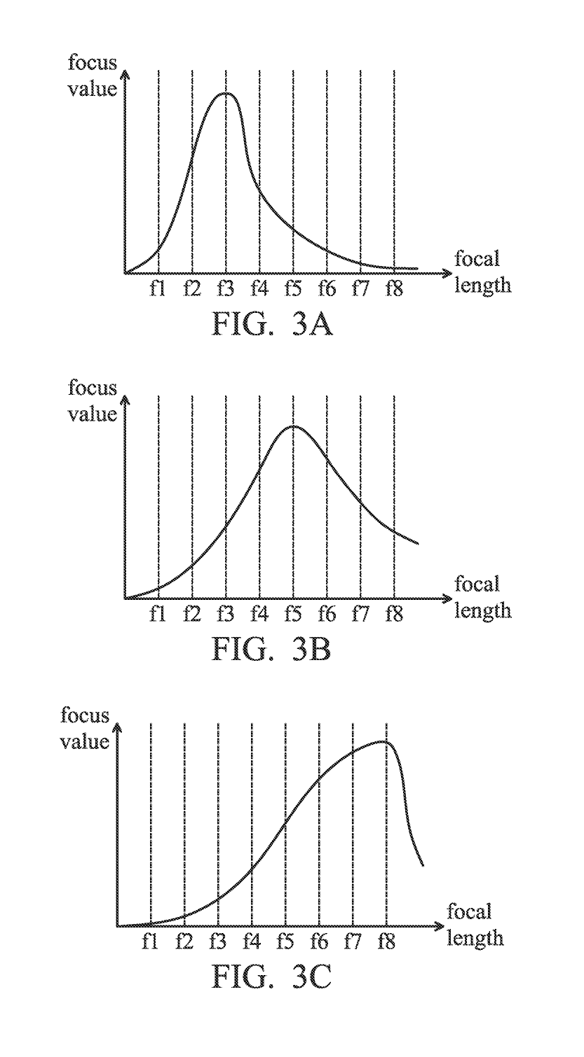

For example, when a user needs to obtain an image focusing on object A, the processing unit 110 determines the image-contrast value of area Aa in each of the images stored in the memory unit 108. It is described in FIG. 3A for example. In the embodiment of FIG. 3A, the lens 104 can be adjusted to focal lengths f1, f2, f3, f4, f5, f6, f7 and f8, the photosensitive unit 106 obtains eight images corresponding respectively to focal lengths f1, f2, f3, f4, f5, f6, f7 and f8, and the processing unit 110 calculates a focus value (such as an image-contrast value) of area Aa in each of the images for the focal lengths f1-f8. As shown in FIG. 3A, the focus value of the image for focal length f3 is the highest of the eight images. Therefore, the processing unit 110 determines that the image for focal length f3 is the target image.

Similarly, when a user needs to obtain an image focusing on object B, the processing unit 110 determines the image-contrast value of area Ab in each of the images stored in the memory unit 108. As shown in FIG. 3B, the focus value of the image for focal length f5 is the highest of the eight images. Therefore, the processing unit 110 determines that the image for focal length f5 is the target image. Also, when the user needs to obtain an image focusing on object C, the processing unit 110 determines the image-contrast value of area Ac in each of the images stored in the memory unit 108. As shown in FIG. 3C, the focus value of the image for focal length f8 is the highest of the eight images. Therefore, the processing unit 110 determines that the image for focal length f8 is the target image. It should be noted that the range of areas Aa, Ab and Ac can be set according to the user's design. In some embodiments, the processing unit 110 determines the range of the selected area according the size of the focal object.

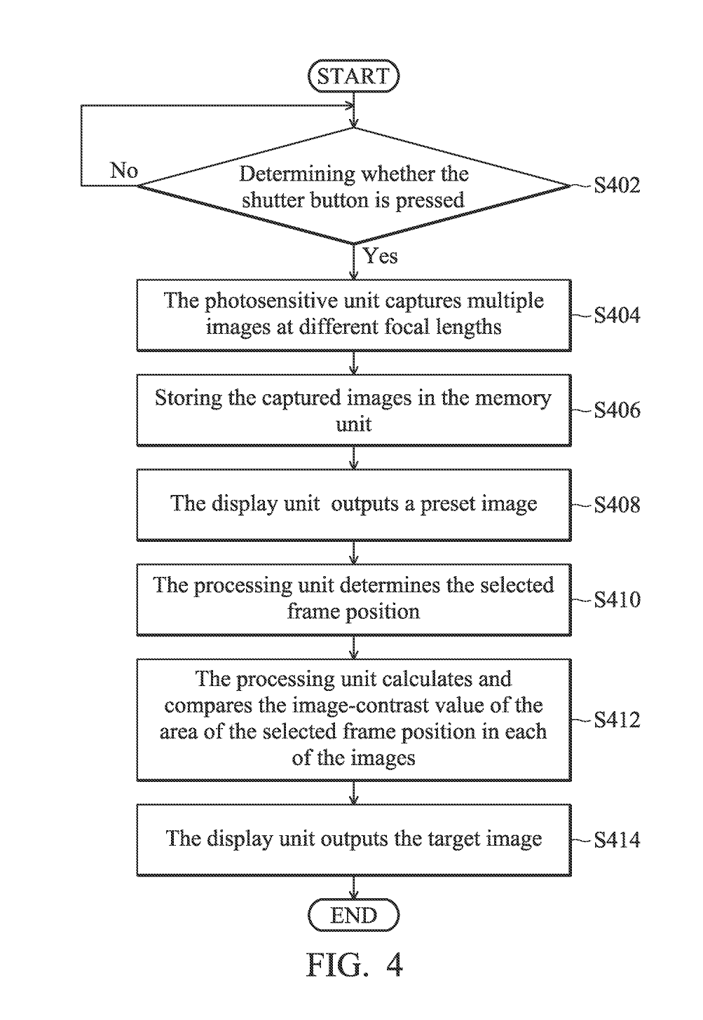

FIG. 4 is a flowchart of an embodiment of an operation method for the image-capturing device shown in FIG. 1. At first, in step S402, the processing unit determines whether the shutter button is pressed by a user, and step S404 is performed when the shutter button is pressed. In step S404, the photosensitive unit 106 captures multiple images at different focal lengths via the lens 104 from an external scene. In step S406, the memory unit 108 stores the captured images. Next, in step S408, the display unit 112 outputs one of the images as a preset image for preview.

Next, in step S410, the processing unit 110 determines the selected frame position. In step S412, the processing unit 110 calculates the image-contrast value of the area of the selected frame position in each of the images, and determines which image has the highest image-contrast value. Finally, in step S414, the display unit 112 outputs the target image having the highest image-contrast value.

The present invention may also be at least partially embodied in the form of computer program code embodied in tangible machine-readable storage media, such as random access memory (RAM), read only memories (ROMs), CD-ROMs, DVD-ROMs, BD-ROMs, hard disk drives, flash memories, or any other machine-readable storage medium, wherein, when the computer program code is loaded into and executed by a computer, the computer becomes an apparatus for practicing the invention. The present invention may be embodied at least partially in the form of computer program code, whether loaded into and/or executed by a computer, such that, when the computer program code is loaded into and executed by a computer, the computer becomes an apparatus for practicing the invention. When implemented on a general-purpose processor, the computer program code segments configure the processor to create specific logic circuits. The invention may alternatively be at least partially embodied in a digital signal processor formed of application-specific integrated circuits for performing a method according to the principles of the invention.

The particular feature, structure or character described in “an embodiment” or “an example” of the present specification should be included in at least one embodiment of the present specification. Therefore, the statement of “in an embodiment” appearing in different places in the specification may not refer to the same embodiment. In addition, this particular feature, structure or character, may be incorporated with one or more embodiments in any suitable way.

One skilled in the art can easily understand the advantages of the embodiments mentioned above. After reading the present specification, those who are skilled in this technology can still make various alterations and modifications without departing from the scope and spirit of this invention. Accordingly, the present specification is used for protecting the scope of the claims of the present invention, and it is not intended to limit the present invention. Further, the present invention may repeat the same index numerals and/or words in different embodiments. The repeated numerals and/or words are used to simplify and clarify the present invention, and do not indicate that the structures in the different embodiments must have the same characteristics.

What is claimed is:

1. An image-capturing device, comprising:
a lens, having an adjustable focal length;
a photosensitive unit, obtaining a plurality of images from a scene via the lens, and the images are corresponding to different focal lengths of the lens individually;
a memory unit, storing the images;
a processing unit, obtaining a target image from the images according to a selected frame position; and
a display unit, outputting the target image,
wherein the lens with the corresponding focal length of the target image focuses on an object of the scene, and the object is located at the selected frame position of the target image.

2. The image-capturing device of claim 1, wherein the processing unit further obtains an image-contrast value for a predetermined area of the selected frame position of each image, and determines the target image according to the image-contrast values of the images.

3. The image-capturing device of claim 2, wherein the processing unit further compares the image-contrast values of the images to each other, and the image having the highest image-contrast value is the target image.

4. The image-capturing device of claim 1, further comprising: a lens-control unit, configured to drive the movement of the lens to adjust the focal length of the lens.

5. The image-capturing device of claim 1, wherein after the photosensitive unit captures the images, the display unit outputs a preset image of the

6. An image-capturing method, for an image-capturing device having a lens with an adjustable focal length, the method comprising:
obtaining a plurality of images from a scene via the lens, and the images are corresponding to different focal lengths of the lens individually;
storing the images;
obtaining a target image from the images according to a selected frame position; and
outputting the target image,
wherein the lens with the corresponding focal length of the target image focuses on an object of the scene, and the object is located at the selected frame position of the target image.

7. The image-capturing method of claim 6, further comprising:
obtaining an image-contrast value for a predetermined area of the selected frame position of each image; and
determining the target image according to the image-contrast values of the images.

8. The image-capturing method of claim 7, further comprising:
comparing the image-contrast values of the images to each other, wherein the image having the highest image-contrast value is the target image.

9. The image-capturing method of claim 6, further comprising:
driving the movement of the lens to adjust the focal length of the lens by a lens-control unit.

10. The image-capturing method of claim 6, further comprising:
outputting a preset image of the images according to a preset focal length, after the images are captured.
